(19) United States
(12) Patent Application Publication
(10) Pub. No.: US 2021/0023724 A1
(43) Pub. Date: Jan. 28, 2021

(54) Utility Knife

(71) Applicant: JS Products, Inc., Las Vegas, NV (US)

(72) Inventor: Richard Yang, Las Vegas, NV (US)

(21) Appl. No.: 16/947,261

(22) Filed: Jul. 24, 2020

Related U.S. Application Data
(60) Provisional application No. 62/878,298, filed on Jul. 24, 2019.

(51) Int. Cl. B26B 1/04; B26B 1/10; B26B 9/02

(52) U.S. Cl. CPC B26B 1/042; B26B 11/006; B26B 9/02; B26B 1/10

(57) ABSTRACT

A utility knife includes a knife body that has a knife frame and an ergonomic outer casing attached to the knife frame. The utility knife also includes a retractable blade holder that holds a blade. The retractable blade holder extends out of and retracts into the knife body and may also be selectively oriented at a first angle and a second angle relative to a longitudinal axis of the knife body.

### CROSS REFERENCE TO RELATED APPLICATION

This application claims priority to U.S. Provisional Application No. 62/878,298, which was filed on Jul. 24, 2019, the contents of which are hereby incorporated by reference.

### BACKGROUND

Utility knives are popular for indoor and outdoor use and come in several varieties. For example, there are fixed blade knives, folding knives, retractable knives and the like. These types of utility knives are designed as multi-purpose cutting tools for use in a variety of trades and crafts. Designed to be lightweight and easy to carry and use, utility knives are commonly used in factories, warehouses, construction projects, and other situations where a tool is routinely needed to mark cut lines, trim plastic or wood materials, or to cut tape, cord, strapping, cardboard, or other packaging material (See e.g. Utility knife, Wikipedia, The Free Encyclopedia, https://en.wikipedia.org/wiki/Utility_knife).

### SUMMARY

A newer, more convenient utility knife is described herein. According to one embodiment, a utility knife includes a knife body that has a knife frame with an elongated channel extending parallel to a longitudinal axis of the knife body. The elongated channel may include a main portion, an angled extending portion, and cutout portions. The cutout portions may extend outward from the elongated channel. The knife also includes a blade holder disposed within the knife body adjacent to the knife frame. The blade holder may have at least one guide that engages with the elongated channel. The blade holder may also have a locking tab that engages with both the elongated channel and the cutout portions.

The blade holder may also include a depressible button attached to the locking tab. The depressible button allows a user to move the locking tab out of engagement from the cutout portions. This allows the blade holder to move along the engaged channel until the locking tab engages another cutout. The blade holder may have a biasing spring to bias the locking tab into engagement with the cutout portions.

In some embodiments, the blade holder includes a blade release mechanism to release a blade held by the blade holder. The knife body may have a blade release button that aligns with the blade release mechanism and actuates the blade release mechanism.

In one exemplary embodiment, when one of the guides is moved into the angled extending portion of the elongated channel, a blade held by the blade holder becomes angled relative to the longitudinal axis of knife. This may place the blade in a more convenient orientation for certain tasks. In some instances, the blade is angled relative to the longitudinal axis at an angle between 10 and 40 degrees.

In one embodiment, the knife also has a blade storage. The blade storage includes a first end that is pivotally connected to the knife body and a second end that releasably rotates away from the knife body. The knife frame may have first and second outer frames and an inner frame disposed between the first and second outer frames. The blade holder may be disposed between the first outer frame and the inner frame, and the blade storage may be disposed between the inner frame and the second outer frame. The knife body may include a storage release that releases the second end of the blade storage upon actuation.

In another exemplary embodiment a utility knife may include a knife body that has a knife frame and an ergonomic outer casing attached to the knife frame. The utility knife may also have a retractable blade holder configured to hold a blade. The retractable blade holder may extend out of and retract into the knife body, and may be selectively oriented at a first angle and a second angle relative to a longitudinal axis of the knife body.

The knife frame may include an elongated channel that has a main portion and an angled portion. The retractable blade holder may have first and second guides that engage the elongated channel. In this manner, the retractable blade holder may be oriented at the first angle while the first and second guides engage the main portion, and the retractable blade holder may be rotated towards the second angle when at least one of the first and second guides engages the angled portion.

In some embodiments, the elongated channel includes cutouts, and the retractable blade holder includes a locking tab configured to engage the elongated channel and the cutouts. In this way, the locking tab locks the retractable blade holder into one of a plurality of positions corresponding to the cutouts when the locking tab engages the cutouts. For example, the cutouts may include a first, second, third, and fourth cutout. The first cutout may correspond to a retracted position. The second cutout may correspond to a box cutter position. The third cutout may correspond to an extended straight position where the extended straight position is a position where the retractable blade holder extends at the first angle. The fourth cutout may correspond to an extended angled position where the extended angled position is a position where the retractable blade holder extends at the second angle.

The retractable blade holder may include a depressible button attached to the locking tab where the depressible button releases the locking tab from the cutouts. In some instances, the first angle is between 0 and ten degrees and the second angle is between 10 and 40 degrees.

In an exemplary embodiment, the knife has a blade storage with a first end pivotally connected to the knife body and a second end that releasably rotates away from the knife body. The knife frame may include first and second outer frames and an inner frame disposed between the first and second outer frames. The retractable blade holder may be disposed between the first outer frame and the inner frame, and the blade storage may be disposed between the inner frame and the second outer frame. The knife body may include a storage release that releases the second end of the blade storage upon actuation. In some instances, a folding tool may be disposed between the inner frame and the second out frame.

### BRIEF DESCRIPTION OF THE DRAWINGS

FIG. 1A, FIG. 1B, and FIG. 1C show a utility knife with a blade in different positions, according to one exemplary embodiment.

FIG. 2 shows internal parts of a utility knife with a linear and angular adjustable blade, according to an exemplary embodiment.

FIG. 3 shows an exemplary laminate part of a utility knife according to one embodiment.

FIG. 4 shows a blade holder of a utility knife according to one exemplary embodiment.

FIG. 5A, FIG. 5B, and FIG. 5C show views of a utility knife with a swing-out replacement blade storage, according to one exemplary embodiment.

FIG. 6A and FIG. 6B shows exemplary tools added to a utility knife, according to exemplary embodiments.

The components in the figures are not necessarily to scale, emphasis instead being placed upon illustrating the principles of the invention. In the figures, like reference numerals designate corresponding parts throughout the different views.

### DETAILED DESCRIPTION OF EMBODIMENTS

Aspects of the present disclosure may be embodied as a utility knife, and in particular, a utility knife that also is useful as a carpet knife. The utility knife includes a blade holder that is slidable with reference to a knife body. The knife body is formed with an elongated channel that has an angled extending portion. Guides formed in the blade holder follow the elongated channel and position the blade holder either parallel to the knife body or at an angle to the knife body.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided to give a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

The description of elements in each figure may refer to elements of proceeding figures. Like numbers refer to like elements in all figures, including alternate embodiments of like elements.

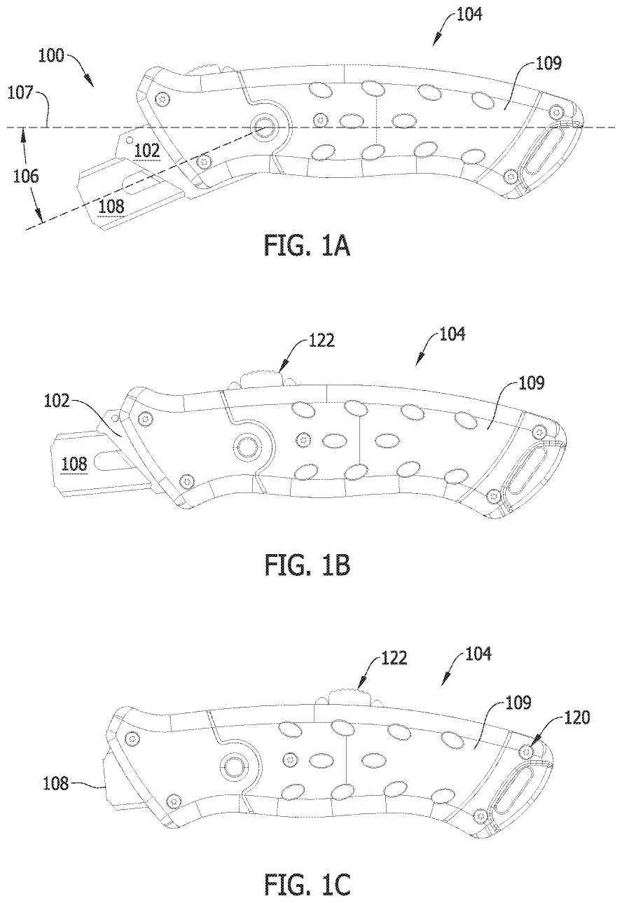

FIGS. 1A-1C are side view diagrams illustrating embodiments of a utility knife 100 in accordance with embodiments of the present invention. The diagrams illustrate different positions of a sliding blade holder 102 with reference to a knife body 104. As will be described in greater detail below, the blade holder 102 is configured to transition between at least two positions, a retracted position and an extended position. In one extended position, as depicted in FIG. 1A, the blade holder 102 is oriented at an angle 106 with reference to a longitudinal axis 107 of the knife body 104. In one embodiment, the angle 106 is in the range of between about 10 and 40 degrees. In a further embodiment, the angle 106 is in the range of between about 20 and 25 degrees. The angle 106 may be predetermined according to an optimum angle for a selected task. For example, an angle of about 23 degrees may be optimum for use as a carpet knife.

In further embodiments, the blade holder 102 is transitionable, or moveable, between at least four different lockable positions. The different positions may include, but are not limited to, a retracted position, an extended and angled position (as in FIG. 1A), an extended straight position (as in FIG. 1B), and a partially extended position (as in FIG. 1C). Each position is useful for a different purpose. For example, the retracted position, where the blade 108 and blade holder 102 are completely withdrawn into the knife body 104, is useful for safely transporting the utility knife 100. The extended and angled position of FIG. 1A is useful as a carpet cutting utility knife. The extended and straight position of FIG. 1B (that is, where the angle between the blade holder 102 and the longitudinal axis 107 is small, such as between 0 and 10 degrees) is useful for general use purposes, and the partially extended position of FIG. 1C is useful for cutting boxes, for example.

The blade holder 102 is configured for holding, in one embodiment, a carpet blade. Carpet blades, as known to those skilled in the art, are generally flat with an overall rectangular shape, with opposing sharpened edges for cutting. Carpet blades generally include an elongated slot in a central position. However, it should be understood that the blade holder 102 may be modified to hold other types of utility blades, and not just carpet blades.

The knife body 104 of FIGS. 1A-1C is formed of a durable and rigid material. In one example, the knife body 104 is formed of metal, such as, but not limited to steel. The knife body 104 may be formed of different layers, or in other words, have a laminate style construction. In some embodiments, the knife body 104 may be formed from two more steel layers which are attached together via fasteners 120 to form the knife body 104. The steel layers may be stamped from sheet metal and may be machine finished to form the desired shape. In some embodiments, a thermoplastic rubber or other suitable material may be molded over or may be snap fitted onto the outer layers of the knife body to form an ergonomic handle. Depicted in FIGS. 1A-1C therefore, is an outer layer or casing 109. The outer layer or casing 109 may also be attachable to knife body via the fasteners 120. The fasteners 120, in one example, are screws.

The blade holder 102 is configured to slide within and at least partially out of the knife body 104, as will be described below in greater detail. Attached to the blade holder 102 is a depressible button 122. The button 122 is configured to release the blade holder 102 from one of a plurality of lockable positions.

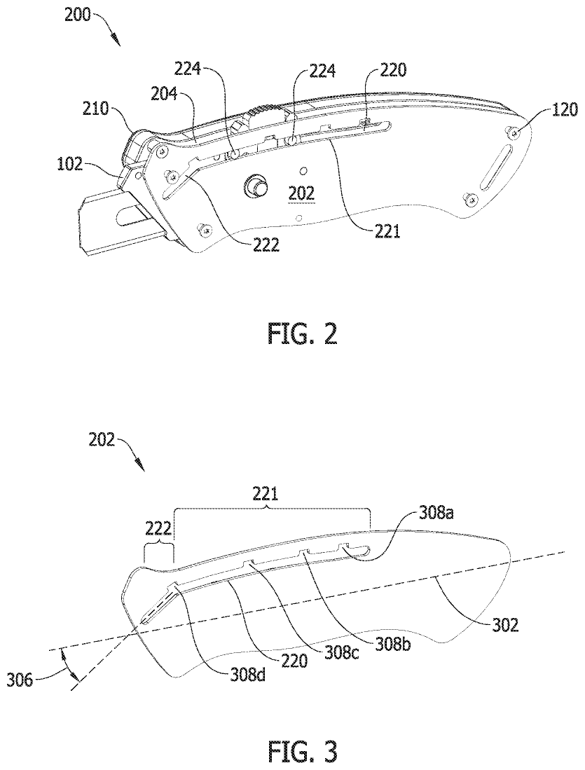

FIG. 2 is a perspective view diagram illustrating one embodiment of a knife frame 200 in accordance with embodiments of the present invention. The knife frame 200, as described above, may be laminate in nature. In other words, sheets of metal may be attached to each other via the fasteners 120 to form the knife frame 200. In the depicted embodiment, a first outer frame 202 is coupled with an interior frame 204. Disposed between the outer and interior frames 202, 204 is the sliding blade holder 102. A second outer frame 210 is disposed on the other side of the interior frame 204 from the first outer frame 202. The second outer frame 210 may allow for additional features to be added to the knife 100 as will be described in more detail below. In some embodiments, the knife frame 200 may include only the frames 202, 204, in which case the interior frame 204 would be considered the second outer frame.

The first outer frame 202 may be substantially identical in shape and configuration to the interior frame 204. In both frames 202, 204 there may be formed a channel 220. The channel 220 extends substantially along the entire length of the frames 202, 204. The channel 220, in one embodiment, includes a main portion 221 and an angled extending portion 222. Guides 224 extending outward from the blade holder 102 engage the channel 220 in each of the frames 202, 204 and direct the movement of the blade holder 102 with reference to the knife frame 200. In other words, the guides 224 follow the channel 220 and direct the blade holder 102 to be either parallel with the knife frame 200 (i.e. with longitudinal axis 107 shown in FIG. 1A) when the guides are in the main portion 221 or angled with the knife frame 200 (i.e. with longitudinal axis 107 shown in FIG. 1A) when at least one of the guides 224 is positioned in the angled extending portion 222.

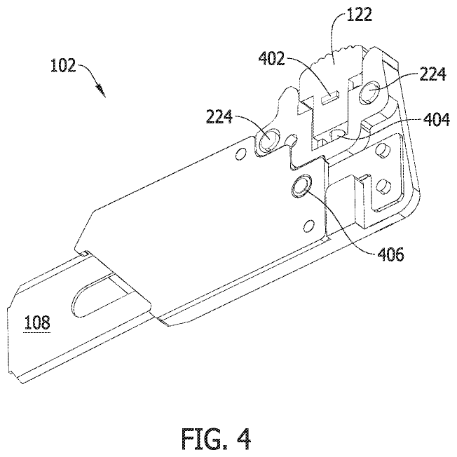

FIG. 3 is a perspective view drawing illustrating another embodiment of the outer frame 202 in accordance with embodiment of the present invention. As described above with reference to FIG. 2, the elongated channel 220 includes an angled extending portion 222. The main portion 221 of the elongated channel 220 extends along the length of the outer frame 202 in a direction that is generally parallel to a longitudinal axis 302 of the outer frame 202. The angled extending portion 222 extends downward at an angle in the range of between about 10 and 45 degrees. In one embodiment, the angle 304 is in the range of between about 20 and 25 degrees. The angle 304 may be selected to optimize use of the utility knife for a particular function. For example, it has been found that an angle resulting in the blade 108 (see FIG. 1A) being about 23 degrees from the longitudinal axis 302 is optimal for use as a carpet knife.

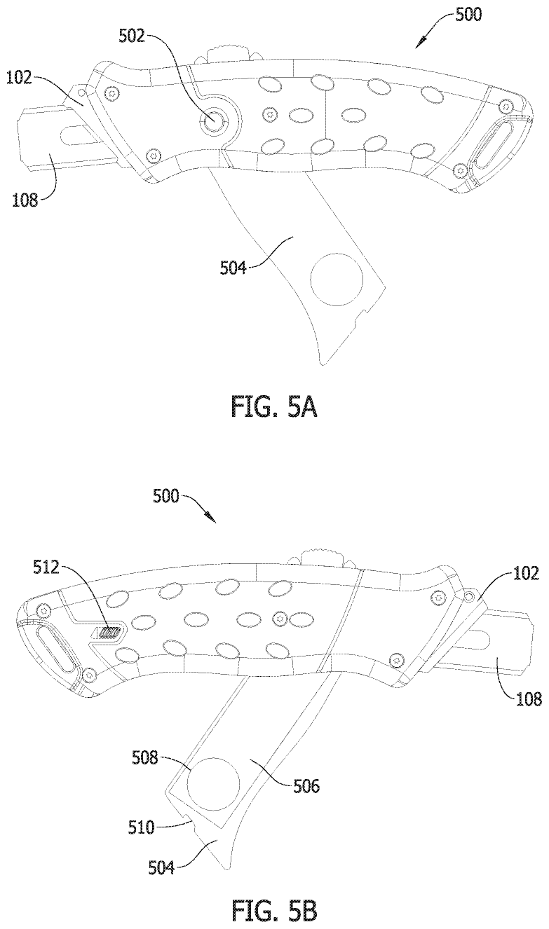

In one embodiment, the elongated channel 220 includes a number of cutout portions 308. The cutout portions 308 are configured to engage a locking tab that extends outward laterally from the button 122, as will be described below in greater detail with reference to FIG. 4. In one embodiment, the elongated channel 220 includes at least one cutout portion 308 for locking the blade holder inside the knife body. In other embodiments, the elongated channel 220 includes two or more cutout portions 308 for locking the blade holder in various positions. Examples of these positions include a stored position 308a for storing the blade holder inside the knife body, a partially extended position 308b for allowing a portion of the blade to extend out of the knife body, a fully extended but parallel position 308c, and a fully extended and angled position 308d. Depressing the button 122 disengages the locking tab from one of the cutout portion 308 positions and allows the blade holder 102 to slide with reference to the knife body 104 (See FIGS. 1A-1C).

FIG. 4 is a side perspective view diagram illustrating one embodiment of the blade holder 102 in accordance with an exemplary embodiment. The blade holder 102, as described above, is configured to hold the blade 108. The blade holder 102 is configured to slide within and at least partially out of the knife body 104. The guides 224 engage the elongated channel 220 and direct the blade holder 102 according to the path defined by the elongated channel 220 (see FIGS. 2-3). As shown, the guides 224 may include a first and second guide, one of which is forward from the button 122, and one which is rearward from the button 122.

Therefore, in the example of FIG. 2, the blade holder 102 extends from a stored position in a path that is substantially parallel to the longitudinal axis 107 of the knife body 104 (see FIG. 1) until at least the leading guide 224 encounters the angled extending portion 222 of the elongated channel 220. At this point, the guide 224 causes the blade holder 102 to begin to slide along an angled path with reference to the knife body 104.

The blade holder 102, in one embodiment, includes at least two guides 224 to maintain the position of the blade holder 102 with reference to the knife body 104. The guides 224, although depicted as substantially circular, may be formed in any shape that is consistent with the elongated channel 220. In other words, square or rectangular guides may be designed and formed that engage with the channel 220. The guides 224 extend outward in a direction substantially perpendicular to a direction of travel of the blade holder 102. Stated differently, the guides 224 extend outward laterally while the blade holder 102 travels longitudinally with reference to the knife body 104.

The locking tab 402 extends outward laterally from the button 122 and is coupled with the button 122. In some embodiments, the locking tab 402 is integrally formed with the button 122. The locking tab 402 is depicted here as a substantially rectangular member protruding from the button 122. However, the locking tab 402 may be any shape that is configured to engage a cutout portion 308 of the elongated channel 220. For example, if the cutout portions 308 have rectangular profiles, the locking tab 402 may also have a rectangular profile configured to engage the cutout portion 308. Alternatively, the locking tab 402 may be shaped in a manner similar to the guides 224.

In one embodiment, the button 122 is biased with reference to the blade holder 102. This allows a person to depress the button 122 and have the button return to a locked position by engaging the locking tab 402 with a cutout portion 308 when the locking tab aligns with the cutout portion 308. In one example, a spring 404 is disposed between the button 122 and the blade holder 102 and provides the biasing force. The spring 404, in one embodiment, is a compression spring configured to apply a force to the button 122 that causes the button 122 to move away from the blade holder 102.

Thus, referring to each of FIGS. 1A-1C, 3, and 4, a user may adjust the position of the blade 108 along the knife body 104 as follows. Starting from a fully retracted position where the locking tab 402 is in cutout 308a, the user may press the button 122 to disengage the locking tab 402 from the cutout 308a to allow the blade holder 102 to advance along the channel 220 to expose the blade 108 from the knife body 104. When the locking tab 402 aligns with the cutout 308b, the biasing spring 404 engages the locking tab with the cutout 308b, locking the blade holder 102 in the position shown in FIG. 1C so that the blade 108 is only slightly extended.

This process is then repeated by again engaging the button 122 to release the locking tab 402 from the cutout 308b to allow the blade holder to again move along the channel until the biasing spring 404 engages the locking tab with the cutout 308c. The blade 108 is then in the position shown in FIG. 1B. The user may then again press the button 122 to release the locking tab 402 from the cutout 308c. As the user moves the blade holder 102 along the channel, the front guide 224 will enter the angled extending portion 222 of the channel 222 to cause the angle of the blade holder 102 and blade 108 to change with respect to the longitudinal axis 107 of the knife body 104. When the locking tab 402 aligns with the cutout 308d, the biasing spring 404 engages the locking tab 402 with the cutout 308d locking the blade 108 in the position shown in FIG. 1A. This process is reversed to retract the blade holder 102 and blade 108.

Returning to FIG. 4, the blade holder 102 further comprises a blade release aperture 406. The blade release aperture 406 allows access to a blade release mechanism to remove the blade 108 from the blade holder 102 to replace the blade 108. The blade release mechanism may be actuated by a projection disposed on a button on the knife body, as discussed in more detail below. When the projection actuates the blade release mechanism, the blade 108 may be removed from the blade holder 102.

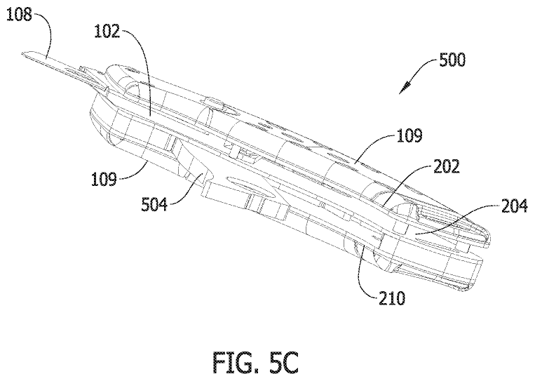

FIG. 5A-5C show a utility knife with a swing-out, replacement blade storage, according to an exemplary embodiment. The utility knife 500 is similar to utility knife 100 in that it includes the retractable blade holder 102 with a blade 108 that may be extended from the utility knife 500 both straight and at an angle relative to the utility knife 500. The utility knife 500 comprises a blade release button 502. The blade release button 502 is configured to align with the blade release aperture 406 (see FIG. 4) to allow the user to release the bade 108 for replacement. In this embodiment, the blade release button 502 only aligns with the blade release aperture 406 of the blade holder 102 when the blade holder is in the straight extended position as shown in FIG. 5A. When the blade holder 102 is in other positions, such as the retracted position or the angled extended position, the blade release button 502 does not align with the blade release aperture 406 which prevents the blade 108 from accidentally being released from the blade holder 102.

Additional replacement blades (not shown) may be stored within the utility knife 500. The utility knife 500 may have a swing-out blade storage 504. In this embodiment, the swing-out blade storage 504 is pivotably connected to the knife 400 towards the front of the knife (the end of the knife from which the blade holder 102 extends and retracts). Thus, the blade storage 504 may swing or fold out from a rear of the knife about the pivoting connection.

As shown in FIG. 5B, the blade storage 504 may comprise a rectangular storage portion 506 in which the replacement blades are kept in the blade storage 504. A through hole 508 is provided to help aid a user in removing the replacement blades from the storage portion 506. In this embodiment, the blade storage further comprises a notch 510. The notch 510 locks the blade storage 504 in the knife 500, such as by interacting with a biased projection that is attached to a storage release 512. Thus, when the user would like to access a replacement blade stored in the blade storage 504, the user actuates the storage release 512 and swings/folds out the blade storage 504. When the user is done with the blade storage 504, the user may swing/fold the blade storage 504 back into the knife 500 and reengage the notch with the storage release 512.

As shown in FIG. 5C, the laminate structure of the utility knife 500 allows for knife 500 to remain convenient and compact while housing both the retractable blade holder 102 and swing-out blade storage 504. As explained above, the blade holder 102 housing the blade 108 is disposed between the first outer frame 202 and the inner frame 204. The swing-out blade storage 504 is disposed between the inner frame 204 and the second outer frame 210. Thus, along with the out layer/casing 109, the knife 500 is a compact, ergonomic utility knife with both the retractable and adjustable angle blade holder 102 and swing-out blade storage 504.

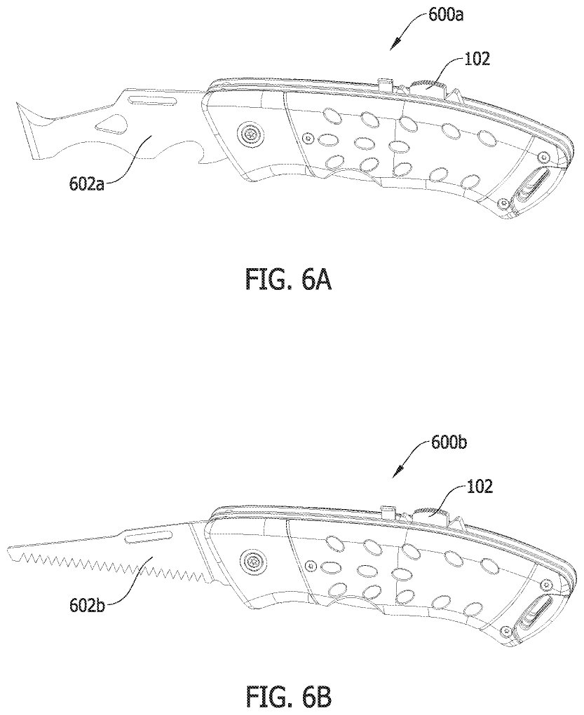

FIG. 6A and FIG. 6B shows exemplary tools added to a utility knife, according to exemplary embodiments. The laminate structure may allow for the addition of further tools. These tools may be added in place of the blade storage or in addition to the blade storage, such as by adding additional frames. In FIG. 6A, a knife 600a is shown with tool holder 102 and an exemplary folding tool 602a. In FIG. 6B, a knife 600b is shown with the tool holder 102 and another exemplary folding tool 602b. Other types and combinations of folding tools may also be incorporated.

In the above description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

It is to be understood that the above description is intended to be illustrative, and not restrictive. Many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

What is claimed is:

1. A utility knife comprising:
a knife body comprising a knife frame having an elongated channel extending parallel to a longitudinal axis of the knife body, the elongated channel comprising a main portion, an angled extending portion, and cutout portions, the cutout portions extending outward from the elongated channel; and
a blade holder disposed within the knife body adjacent to the knife frame, the blade holder comprising at least one guide configured to engage the elongated channel and a locking tab configured to separately engage the elongated channel and the cutout portions.

2. The utility knife of claim 1, wherein the blade holder further comprises a depressible button attached to the locking tab, the depressible button configured to move the locking tab out of engagement with the cutout portions.

3. The utility knife of claim 2, wherein the blade holder further comprises a biasing spring to bias the locking tab into engagement with the cutout portions.

4. The utility knife of claim 1, wherein the blade holder further comprises a blade release mechanism to release a blade held by the blade holder.

5. The utility knife of claim 4, wherein the knife body comprises a blade release button that aligns with the blade release mechanism and actuates the blade release mechanism.

6. The utility knife of claim 1, wherein when the at least one guide is moved into the angled extending portion of the elongated channel, a blade held by the blade holder becomes angled relative to the longitudinal axis.

7. The utility knife of claim 6, wherein the blade is angled relative to the longitudinal axis at an angle between 10 and 40 degrees.

8. The utility knife of claim 1, further comprising a blade storage, the blade storage comprising a first end pivotally connected to the knife body, and a second end that releasably rotates away from the knife body.

9. The utility knife of claim 8, wherein the knife frame comprises first and second outer frames and an inner frame disposed between the first and second outer frames, the blade holder being disposed between the first outer frame and the inner frame, and the blade storage being disposed between the inner frame and the second outer frame.

10. The utility knife of claim 8, wherein the knife body comprises a storage release that releases the second end of the blade storage upon actuation.

11. A utility knife comprising:
a knife body comprising a knife frame and an ergonomic outer casing attached to the knife frame; and
a retractable blade holder configured to hold a blade, the retractable blade holder configured to extend out of and retract into the knife body, and to be selectively oriented at a first angle and a second angle relative to a longitudinal axis of the knife body, the first angle being different than the second angle.

12. The utility knife of claim 11, wherein the knife frame comprises an elongated channel including a main portion and an angled portion, the retractable blade holder comprises first and second guides that engage the elongated channel, the retractable blade holder being oriented at the first angle while the first and second guides engage the main portion, and the retractable blade holder rotating towards the second angle when at least one of the first and second guides engaged the angled portion.

13. The utility knife of claim 12, wherein the elongated channel comprises cutouts and the retractable blade holder comprises a locking tab configured to engage the elongated channel and the cutouts, the locking tab locking the retractable blade holder into one of a plurality of positions corresponding to the cutouts when the locking tab engages the cutouts.

14. The utility knife of claim 13, wherein
the cutouts comprise a first, second, third, and fourth cutout;
the first cutout corresponds to a retracted position of the plurality of positions;
the second cutout corresponds to a box cutter position of the plurality of positions;
the third cutout corresponds to an extended straight position of the plurality of positions, the extended straight position being a position where the retractable blade holder extends at the first angle; and
the fourth cutout corresponds to an extended angled position of the plurality of positions, the extended angled position being a position where the retractable blade holder extends at the second angle.

15. The utility knife of claim 13, wherein the retractable blade holder comprises a depressible button attached to the locking tab, the depressible button configured to release the locking tab from the cutouts.

16. The utility knife of claim 11, wherein the first angle is between 0 and ten degrees and the second angle is between 10 and 40 degrees.

17. The utility knife of claim 11, further comprising a blade storage, the blade storage comprising a first end pivotally connected to the knife body, and a second end that releasably rotates away from the knife body.

18. The utility knife of claim 17, wherein the knife frame comprises first and second outer frames and an inner frame disposed between the first and second outer frames, the retractable blade holder being disposed between the first outer frame and the inner frame, and the blade storage being disposed between the inner frame and the second outer frame.

19. The utility knife of claim 17, wherein the knife body comprises a storage release that releases the second end of the blade storage upon actuation.

20. The utility knife of claim 11, wherein the knife frame comprises first and second outer frames and an inner frame disposed between the first and second outer frames, the retractable blade holder being disposed between the first outer frame and the inner frame, and a folding tool being disposed between the inner frame and the second out frame.
